(19) United States
(12) Patent Application Publication
(10) Pub. No.: US 2026/0223886 A1
(43) Pub. Date: Aug. 6, 2026

(54) Production of Organic Pea Protein Isolate

(71) Applicant: Louis Dreyfus Company Plant Proteins LLC, Livermore, CA (US)

(72) Inventors: Manoj Kumar, Livermore, CA (US); Nikolina Bilkic, Livermore, CA (US)

(21) Appl. No.: 19/047,494

(22) Filed: Feb. 6, 2025

(51) Int. Cl. A23J 1/14; A23J 3/14; A23L 33/185

(52) U.S. Cl. CPC A23J 1/14; A23J 3/14; A23L 33/185

(57) ABSTRACT

The present disclosure provides a process for producing pea protein products, in particular pea protein isolates (PPIs), PPI produced by the process and use of PPI, wherein the process utilizes lactic acid or L-Malic acid to precipitate PPI (lactic acid PPI and malic acid PPI, respectively) from a protein-rich solution derived from a pea source. The process comprises steps of a) providing a pea source, b) extracting protein from the pea source in a basic solution to produce a protein—rich solution, c) separating the remaining pea source from the protein-rich solution, and d) precipitating protein from the protein-rich solution by adding lactic acid or L-Malic acid to lower the pH, thereby producing PPI.

### BACKGROUND

Typically, pea protein isolate (PPI) is produced by the isoelectric precipitation method using conventional inorganic acids such as hydrochloric and sulfuric acids. However, for production of organic pea protein isolate, conventional inorganic acids are not accepted by the USDA for organic certification. A commonly used replacement of conventional inorganic acids is citric acid, which is allowed for organic production processes including commercially available organic PPI. Organic PPI produced using citric acid suffer from bitter and astringent taste. Therefore, there is a need to develop methods of producing pea protein isolate which qualify for organic certification.

### SUMMARY OF THE INVENTION

Organic acids listed by the USDA in its allowed substance list for organic certification (7 C.F.R. § 205.605), other than citric acid, are lactic acid and L-malic acid, which have been not reported for production of organic PPI. The inventors have determined that lactic acid or malic acid can be a suitable organic acid for production of organic PPI. Surprisingly, not only are lactic acid and L-Malic acid quite effective for producing high quality organic PPI, but each had significantly superior organoleptic properties compared with PPI produced with citric acid. Thus, this invention disclosure provides methods for producing high-quality organic PPI without compromising PPI yield and rendering clean tasting organic PPI and/or lower sodium content organic PPI.

Provided herein are methods for producing a pea protein product, typically a pea protein isolate (PPI), by conventional plant protein processing procedures but with the distinguishing feature of using lactic acid or M-malic acid to precipitate pea protein from a protein-rich solution to obtain the PPI. In one embodiment, a process for producing a pea protein product is provided comprising isoelectric precipitation of protein from a protein-rich solution derived from a pea source, wherein the precipitation is induced by adding lactic acid or L-Malic acid to the solution to lower the pH. In some cases, the lactic acid or L-malic acid is the only acid used to induce precipitation. In some embodiments, only lactic acid is used. In other embodiments, only L-Malic acid is used.

In an expanded embodiment of the invention, a process for producing pea protein isolate is provided comprising a) providing a pea source, b) extracting protein from the pea source in a basic solution to produce a protein-rich solution, c) separating the pea source from the protein rich solution, d) precipitating pea protein from the protein-rich solution by reducing the pH of the solution by adding lactic acid or L-Malic acid to obtain a pea protein isolate. In some embodiments, the pea source is pea pulse. In certain embodiments, the pea source is pea pulse flour. In some embodiments the pea pulse flour is from a yellow pea. In some embodiments, the basic solution is an aqueous solution. In certain embodiments, the extraction is performed at pH 7.0-10.5; in certain embodiments the extraction is performed at pH 7.5-9.5. In some embodiments, the separating of the pea source is by centrifugation, filtration or decanting. In certain embodiments, the precipitation is performed using lactic acid only; in other embodiments the pea protein precipitation is performed using L-Malic acid only. In some embodiments, the lactic acid is food grade (FG) lactic acid. In certain embodiments, the lactic acid is 88% FG lactic acid. In some embodiments, the pH is lowered to below 5.0 in the precipitation step. In certain embodiments, the pH is lowered to about 4.5 in the precipitation step.

In some embodiments of the invention, the process for producing pea protein isolate further comprises one or more of i) removing the solution from the protein isolate, ii) optionally washing the protein isolate with a solution at precipitation pH, iii) diluting the protein isolate with water at about pH 7, iv) optionally neutralizing the protein isolate to about pH 7 using sodium hydroxide or sodium hydroxide with magnesium hydroxide and/or potassium hydroxide, v) homogenizing the diluted protein, vi) optionally sterilizing the protein isolate and vii) drying the protein isolate. In certain embodiments, the dilution is with water at about 2× the volume of the protein. In some embodiments the homogenizing is performed using a high pressure homogenizer. In certain embodiments, the sterilizing is performed by direct steam sterilization. In some embodiments, the drying is by spray drying or freeze/spray drying.

In certain embodiments, only sodium hydroxide (NaOH) is used as an alkali in the production process while, in other embodiments, a combination of alkaline solutions of magnesium hydroxide (Mg(OH)₂) and/or potassium hydroxide (KOH) and sodium hydroxide are used for production of lower sodium content Organic PPI. In some embodiments, a combination of alkaline solutions of Mg(OH)₂ and/or KOH and NaOH are used in the neutralizing of the protein isolate. In certain embodiments, a combination of NaOH with Mg(OH)₂ and/or KOH is used in the extraction of the protein from the pea source.

In another embodiment of the invention is provided a pea protein product produced by the processes described above. In certain embodiments, the pea protein product is at least 80% protein (wt/wt, dry basis). In some embodiments, the pea protein product is organic by USDA Organic certification standards.

As compared with a pea protein isolate produced using 1N HCl to precipitate the protein (baseline PPI) but otherwise produced using similar conditions, the PPI produced using lactic acid to induce precipitation (lactic acid PPI) protein yield was similar and protein composition was the same. Lactic acid PPI has equivalent or higher solubility in water under standard, high shear, high temperature and high shear/high temperature conditions and higher viscosity at 25° C. than baseline PPI. Lactic acid PPI also had similar oil holding capacity and water holding capacity to baseline PPI.

Similarly, PPI using L-Malic acid to induce precipitation of the protein in the process (malic acid PPI) also produced a similar product to baseline PPI, with similar protein content and the same composition. The malic acid PPI had similar standard and high shear solubility as baseline PPI, with perhaps somewhat higher high temperature solubility.

Sensory analysis (based on degree of difference or DOD), using 5% (w/v) (lactic acid PPI) or 4% solutions (malic acid PPI) were performed using similarly concentrated baseline PPI solutions. Both the lactic acid PPI and malic acid PPI were determined to taste less beany than baseline PPI.

In addition, the use of NaOH in combination with Mg(OH)₂ and/or KOH as an alkaline source results in reduced sodium PPI.

The skilled artisan will recognize the versatility of the present lactic acid PPI and malic acid PPI in food and beverage industry applications where a certified organic product is desired. Additionally, an organic product with reduced sodium would also be recognized as advantageous to the skilled artisan. In certain aspects, the present disclosure provides use of the lactic acid PPI and malic acid PPI of the present disclosure in a food or beverage application. In some embodiments the lactic acid PPI or malic acid PPI has reduced sodium compared with similar PPI produced using only NaOH as the alkylating agent. In some embodiments, the food or beverage application is selected from milk shake, mayonnaise, salad dressing, nutritional supplements and diary alternatives. In certain embodiments, the dairy alternative is selected from creamers, ice cream, yogurt, buttermilk and cheese. In yet other aspects, the present disclosure provides a food or beverage comprising the PPI of the present disclosure.

### DETAILED DESCRIPTION OF THE INVENTION

The present disclosure provides Pea Protein Isolate (PPI), processes for producing a PPI and uses of the PPI of the invention. The disclosure also provides use of the PPI of the present invention in food and beverage applications. The PPIs of the invention are produced using lactic acid (lactic acid PPI) or L-Malic acid (malic acid PPI) to precipitate protein from a solution of protein extracted from a pea source. The lactic acid PPI and malic acid PPI have the advantage over PPI prepared similarly but using the standard method of precipitating the protein with HCl (baseline PPI) or other non-organic acid of being able to be certified organic. Surprisingly, the lactic acid PPI and malic acid PPI also produce PPI with a less beany flavor than baseline PPI while maintaining similar or better functionality in terms of solubility, viscosity, oil holding content and water holding content. The lactic acid PPI and malic acid PPI may also have reduced sodium due to the use of NaOH with Mg(OH)₂ and/or KOH as an alkaline agent rather than NaOH alone.

Before the present processes, compositions and uses are described, it is to be understood that this invention is not limited to the particular methods or compositions described, which may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supersedes any disclosure of an incorporated publication to the extent there is a contradiction.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It must be noted that as used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Definitions

“Solubility” means the ability of a PPI to dissolve in water.

“Standard Solubility” means the percentage of 2 grams PPI to dissolve in 48 g water at 25° C. after stirring at 700-800 rpm for 1 hour, adjusting pH to 7.0, stirring for another hour, then centrifuging at 15,000 g for 15 minutes. Percentage of protein in supernatant s divided by percentage of protein in the initial solution (4%).

“High Shear Solubility” means the percentage of 2 grams PPI to dissolve in 48 g water at 25° C. after stirring at 700-800 rpm for 1 hour, adjusting pH to 7.0, stirring for another hour, then mixing in an IKA Ultra Turrax disperser/homogenizer for 1 minute at 20,000 rpm before centrifuging at 15,000 g for 15 minutes. Percentage of protein in supernatant s divided by percentage of protein in the initial solution (4%).

“High Temperature Solubility” means the percentage of 2 grams PPI to dissolve in 48 g water at 25° C. after stirring at 700-800 rpm for 1 hour, adjusting pH to 7.0, stirring for another hour, then heating to 92° C. for 20 minutes before centrifuging at 15,000 g for 15 minutes. Percentage of protein in supernatant s divided by percentage of protein in the initial solution (4%). “High Shear/High Temperature Solubility” means the percentage of 2 grams PPI to dissolve in 48 g water at 25° C. after stirring at 700-800 rpm for 1 hour, adjusting pH to 7.0, stirring for another hour, then mixing in an IKA Ultra Turrax disperser/homogenizer for 1 minute at 20,000 rpm, followed by heating to 92° C. for 20 minutes before before centrifuging at 15,000 g for 15 minutes. Percentage of protein in supernatant s divided by percentage of protein in the initial solution (4%).

“Centipoise (cP)” means one hundredth of a poise, or one millipascal-second (mPa·s) in SI units (1 cP=10⁻³ Pa·s=1 mPa·s). The poise is the unit of dynamic viscosity (absolute viscosity). Dynamic viscosity has dimensions of force X time/area. The centipoise (1 cP=0.01 P) is more commonly used than the poise itself.

“Dry basis (db)” means without water or without taking into consideration contribution from water.

“Content”, when referring to PPI or pea starch components on a dry basis, means weight to total weight (wt/wt or wt:wt) unless specified otherwise.

“Concentration” means mass per volume (e.g., grams/liter).

“Conventional Sodium PPI” means PPI using only NaOH as the alkali agent for both the extraction of protein from a pea product step and the neutralizing of the PPI step in the processes herein.

“About”, when used in the context of content of a component of a product or composition or a measurement, means ±5% of the cited amount or percentage of the component or measurement.

“Oil Holding Capacity (OHC)” means the amount of oil a PPI can hold at saturation, measured as grams per gram (g/g). This is generally determined by mixing 1 g of dried PPI with 10 mL of oil in a centrifuge tube, vortexed and kept at room temperature for 1 h. The suspension is then centrifuged at 20 g for 30 min and the volume of oil in the sediment is measured.

“Water Holding Capacity (WHC)” means the amount of water a PPI can hold at saturation (g/g). This is generally determined by mixing 1 g of dried PPI with 10 ml of water in a centrifuge tube, vortexed and kept at room temperature for 1 h. The suspension is then centrifuged at 20 g for 30 min and the volume of water in the sediment is measured.

“Degree of Difference (DOD)” is a sensory measure of difference between a control and test article. In the present context, the difference between the flavor of a malic acid PPI or a Lactic acid PPI and a baseline PPI is determined by the methodology of Aust et al., J. Food Science 50 (5): 511-513 (1985). Briefly, panelists scaled overall difference for three pairs of samples-baseline PPI Batch 1 (C1) vs. C1, C1 vs. baseline PPI Batch 2 (C2), and C1 vs. each batch of malic acid PPI. The difference between the control and test was then compared to within-lot and between-lot variability of the control to establish if the control-test difference was significant.

### Processes

Provided herein are processes for producing a pea protein product. In one embodiment, a process of the invention comprises isoelectric precipitation of protein from a protein-rich solution derived from a pea source by inducing precipitation of the protein from the solution by adding lactic acid or L-Malic acid to the solution to lower the pH, thus inducing precipitation of the pea protein. In some embodiments, the isoelectric precipitation induction is exclusive of other acids. In certain embodiments, the isoelectric precipitation is induced using lactic acid. In other embodiments, the isoelectric precipitation is induced using L-Malic acid.

In another embodiment of the invention, a process for producing pea protein isolate is provided. In some embodiments, the process comprises a) providing a pea source, b) extracting protein from the pea source in a basic solution to produce a protein-rich solution, c) separating the pea source from the protein-rich solution, d) precipitating protein from the protein-rich solution by adding lactic acid or L-Malic acid to reduce the pH, inducing isoelectric precipitation to produce a pea protein isolate.

In some embodiments, the pea source is a pea pulse. In certain embodiments the pea source is pea pulse flour; in some case the pea pulse flour is from yellow pea. In some embodiments the basic solution is an aqueous solution.

In some embodiments, the protein extraction step a) is performed at a temperature of about 18° C. to about 95° C. In certain embodiments, the temperature for the salt extraction of step a) is in the range of about 20 to about 95° C., about 25 to about 95° C., about 30 to about 95° C., about 35 to about 95° C., about 40 to about 95° C., about 45 to about 95° C., about 50 to about 95° C., about 55 to about 95° C., about 60 to about 95° C., about 65 to about 95° C., about 70 to about 95° C., about 50 to about 90° C., about 50 to about 85° C., about 50 to about 80° C., about 50 to about 75° C., about 50 to about 70° C., about 60 to about 95° C., about 60 to about 90° C., about 60 to about 85° C., about 60 to about 80° C., about 60 to about 75° C., about 18 to about 60° C., about 18 to about 50° C., about 18 to about 40° C., or about 18 to about 35° C. In certain cases, the temperature for the salt extraction of step a) is in the range of about 55 to about 95° C. In certain cases, the temperature for the salt extraction of step a) is in the range of about 18 to about 60° C.

In certain embodiments, pea protein is extracted from a pea pulse in a solution at pH 7.0 to 10.5. In some embodiments, the extraction is performed at a pH of 7.5 to 9.5. In some embodiments, the protein extraction is performed at a pH of about 7 to 10. In certain embodiments, pH of the extraction step is in the range of pH 7 to 9.5, pH 7 to 9, pH 7 to 8.5, pH 7 to 8, pH 7 to 7.5, pH 7.5 to 10, pH 7.5 to 9.5, pH 7.5 to 9, pH 8 to pH 9.5, or pH 8.5 to 9.5.

In some embodiments, the time for protein extraction of step a) is in the range of about 30 to 60 minutes for extraction. In certain embodiments, the time for salt extraction of step a) is about 30 minutes, 35 minutes, about 40 minutes, about 45 minutes, about 50 minutes, about 55 minutes, or about 60 minutes.

In certain embodiments, the pH of the extraction step is attained using NaOH. In other embodiments, the pH of the extraction step is attained using NaOH in combination with Mg(OH)₂ or KOH or both. In some embodiments, the ratio of NaOH to Mg(OH)₂ or KOH for the extraction step is about 1:1. In other embodiments, the ratio of NaOH to Mg(OH)₂ or KOH is about 120:1. In certain embodiments the ratio of NaOH to Mg(OH)₂ or KOH in the extraction solution is about 2:1 or about 3:1, about 4:1, about 5:1, about 6:1, about 7:1, about 8:1, about 9:1, about 10:1, about 13:1, about 14:1, about 15:1, about 16:1, about 17:1, about 18:1, about 19:1, about 20:1, about 21:1, about 22:1, about 23:1, about 24:1, about 25:1, about 26:1, about 27:1, about 28:1, about 29:1, about 30:1, about 31:1, about 32:1, about 33:1, about 34:1, about 35:1, about 36:1, about 37:1, about 38:1, about 39:1, about 40:1, about 41:1, about 42:1, about 43:1, about 44:1, about 45:1, about 46:1, about 47:1, about 48:1, about 49:1, about 50:1, about 51:1, about 52:1, about 53:1, about 54:1, about 55:1, about 56:1, about 57:1, about 58:1, about 59:1, about 60:1, about 62:1, about 64:1, about 66:1, about 68:1, about 70:1, about 72:1, about 74:1, about 76:1, about 78:1, about 80:1, about 82:1, about 84:1, about 86:1, about 88:1, about 90:1, about 92:1, about 94:1, about 96:1, about 98:1, about 100:1, about 102:1, about 104:1, about 106:1, about 108:1, about 110:1, about 112:1, about 114:1, about 116:1, about 118:1 or about 120:1. In some embodiment, the ration of NaOH to Mg(OH)₂ or KOH in the extraction solution is about 1:1 to about 20:1, about 10:1 to about 50:1, about 30:1 to about 80:1, about 1:1 to about 120:1.

In some embodiments, the protein extraction step a) is optionally done by including one or more types of salt. In some embodiments, the salt is Na, Ca, or Mg salt or combination thereof. In certain embodiments, the salt is selected from NaCl, CaCl₂), MgCl₂, Sodium hexameta phosphate (SHMP), sodium triphosphate (STP), CaPOCl₃, calcium perchlorate, sodium sulfite, sodium bisulfite, sodium thiocyanate and calcium thiocyanate. In certain embodiments, the salt is SHMP, STP, CaPOCl₃ or calcium perchlorate, or combination thereof. In certain embodiments, the salt is SHMP. In certain embodiments, the salt is STP. In certain embodiments, the salt is CaPOCl₃.

In some embodiments, solid concentration of the resultant obtained from the protein extraction step a) is about 3 to 30%. In certain embodiments, solid concentration of the resultant obtained from the salt extraction in step a) is about 3 to 25%, about 3 to 20%, about 10 to 20%, or 15 to 20%.

In some embodiments, separation of the pea source from the protein-rich solution is by centrifugation, filtration or decanting or any one or combination of these. Separation of extracted solids from a plant source are well known in the art and the skilled artisan would easily understand what method would be appropriate.

In certain embodiments of the pea protein isolate production process, precipitation of the protein from the protein-rich solution is induced using lactic acid. In some embodiments, the lactic acid is the only acid source used for induction of isoelectric precipitation of the protein. In certain embodiments, the lactic acid is food grade (FG) lactic acid. In some embodiments the lactic acid is 88% FG lactic acid. In certain embodiments, the lactic acid is 80%-90% lactic acid. In some embodiments, the lactic acid is 80%, 81%, 82%, 83%, 84%, 85%, 86%, 87% 88%, 89% or 90% lactic acid.

In certain embodiments of the pea protein isolate production process, precipitation of the protein from the protein-rich solution is induced using L-Malic acid. In some embodiments, the malic acid is the only acid source used for induction of isoelectric precipitation of the protein. In certain embodiments, the L=Malic acid is 1M L-Malic acid. In other embodiments, the L-Malic acid is 1M-10M. In certain embodiments the L-Malic acid is 0.5M, 1M, 1.5M, 2M, 2.5M, 3M, 3.5M, 4M, 4.5M, 5M, 5.5M, 6M, 6.5M, 7M, 7.5M, 8M, 8.5M, 9M 9.5M or 10M. In some embodiments the L-Malic acid is made using 95% anhydrous L-Malic acid.

In certain embodiments of the pea protein isolate production process, the pH in the precipitation induction step is lowered to less than 5.0. In some embodiments, the pH in the precipitation induction step is lowered to about 4.5. In certain embodiments, pH of the precipitation of protein step is in the range of pH 4.0 to 5.0, pH 4 to 5.5, pH 4-6.0, pH 4.5-6.5, pH 4.0-7.0, pH 4 to 7.5, pH 4 to 7, pH 5 to 8, pH 5 to 7.5, or pH 5 to 7. In certain cases, pH of the salt extraction of step a) is in the range of pH 4 to 7.

In some embodiments, the precipitation time of step c) is about 5 minutes to 60 minutes. In certain embodiments, time for the precipitation of protein of step c) is about 5 minutes, about 10 minutes, about 15 minutes, about 20 minutes, about 25 minutes, about 30 minutes, about 35 minutes, about 40 minutes, about 45 minutes, about 50 minutes, about 55 minutes, or about 60 minutes.

In some embodiments, the precipitation of protein step c) is performed at a temperature in the range of about 18 to about 60° C., about 18 to about 55° C., about 18 to about 50° C., about 18 to about 45° C., about 20 to about 60° C., about 20 to about 55° C., about 20 to about 50° C., about 20 to about 45° C., about 20 to about 40° C., about 25 to about 60° C., about 25 to about 50° C., about 30 to about 60° C., about 30 to about 55° C.

In some embodiments, the lactic acid or L-Malic acid for the precipitation of protein step is at a total concentration of about 0.1 to about 5%. In certain embodiments, the concentration of the salt is in the range of about 0.5 to about 5%, about 0.5 to about 4.5%, about 0.5 to about 4.0%, about 0.5 to about 3.5%, about 0.5 to about 3%, about 0.5 to about 2.5%, about 0.5 to about 2%, about 1 to about 5%, about 1.5 to about 5%, about 2 to about 5%, about 2.5 to about 5%, about 2.5 to about 5%, about 2.5 to about 5%, about 2.5 to about 5%, about 2.5 to about 4.5%, about 2.5 to about 4%, about 2.5 to about 3.5%, or about 2.5 to about 3%. In certain embodiments, the concentration of the salt is 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, or 5%.

In certain embodiments, the process for producing pea protein isolate further comprises isolating the pea protein isolate. This step may comprise one or more of i) removing the solution from the protein isolate, ii) optionally washing the protein isolate with a solution at precipitation pH, iii) diluting the protein with water iv) neutralizing the protein isolate (adjusting the pH to neutral), v) homogenizing the diluted protein isolate, vi) optionally sterilizing the protein and vii) drying the protein isolate.

In some embodiments, the removing the solution from the protein isolate is performed by decanting. Methods or removing a solution from a precipitate are well known in the art.

In some embodiments, the washing is performed with water at the precipitation pH, such as pH about 4 to about 8. In other embodiments, the protein isolate is washed two times at precipitation pH such as pH in the range of about 4 to about 8, pH 4 to 7.5, pH 4 to 7, pH 5 to 8, pH 5 to 7.5, or pH 5 to 7. The washing step is a well-known technique in the art.

In some aspects, the separated protein isolate is diluted with water, creating a protein slurry. The dilution process is a well-known technique in the art, as is creating a protein slurry.

In certain embodiments of the invention, the protein isolate is neutralized. Neutralizing a protein isolate is well known in the art and typically performed by adding NaOH to the isolate to bring the protein isolate to a pH of about 7. In certain embodiments, the neutralizing step is performed using only NaOH. In other embodiments of the invention, the neutralizing comprises adding NaOH and Mg(OH)₂ and/or KOH to the PPI to raise the pH to about neutral. In some embodiments, neutralizing comprises adding NaOH to raise the pH to pH 6.0 to 6.9, then adding Mg(OH)₂ and/or KOH to raise the pH to about pH 7 to about pH 7.5. In certain aspects, the neutralizing comprises adding NaOH to raise the pH to about 6.0, then adding Mg(OH)₂ and/or KOH to raise the pH to about pH 7. In certain aspects, the neutralizing comprises adding NaOH to raise the pH to about 6.2, then adding Mg(OH)₂ and/or KOH to raise the pH to about pH 7. In certain aspects, the neutralizing comprises adding NaOH to raise the pH to about 6.5, then adding Mg(OH)₂ and/or KOH to raise the pH to about pH 7. In certain aspects, the neutralizing comprises adding NaOH to raise the pH to about 6.7, then adding Mg(OH)₂ and/or KOH to raise the pH to about pH 7. In certain aspects, the neutralizing comprises adding NaOH to raise the pH to about 6.9, then adding Mg(OH)₂ and/or KOH to raise the pH to about pH 7. In each of the preceding cases, the NaOH is typically provided as a solution with a concentration of about 1N (4%) NaOH; the Mg(OH)₂ is typically provided as a solution with a concentration of about 1M (5.83%) Mg(OH)₂ and KOH is typically provided as a solution with a concentration of about 1M (5.61%) KOH.

In the neutralization step described above, each of the NaOH, Mg(OH)₂ and KOH, when used, is in the form of a solution. For each alkylating salt, each salt is, independently, about 1M NaOH, 1M Mg(OH)₂ and 1M KOH. In other embodiments, the NaOH, Mg(OH)₂ and KOH is, each in dependently, 0.5M-10M. In certain embodiments the NaOH, Mg(OH)₂ and KOH is, each in dependently, 0.25M, 0.5M, 1M, 1.5M, 2M, 2.5M, 3M, 3.5M, 4M, 4.5M, 5M, 5.5M, 6M, 6.5M, 7M, 7.5M, 8M, 8.5M, 9M 9.5M or 10M.

In some embodiments, the protein slurry is homogenized by means known in the art. For example, a high-pressure homogenizer may be used. The homogenized protein slurry is optionally sterilized and/or pasteurized. Means for sterilizing protein for use in foods are known in the art. In some embodiments, the sterilization temperature is in the range of 75 to 140° C., 80 to 140° C., 90 to 140° C., 100 to 140° C., 75 to 130° C., 75 to 120° C., 75 to 110° C., or 75 to 100° C. An example of such a means is direct steam injection. The protein slurry may be subjected to direct steam injection for between 2 seconds and 10 minutes, such as 2 seconds, 5 seconds, 10 seconds, 15 seconds, 20 seconds, 25 seconds, 30 seconds, 35 seconds, 40 seconds, 45 seconds, 50 seconds, 55 seconds, 1 minutes, 2 minutes, 3 minutes, 4 minutes, 5 minutes, 6 minutes, 7 minutes, 8 minutes, 9 minutes, 10 minutes.

In some aspects, the pea protein isolate (PPI) extraction process further comprises h) drying protein slurry. The protein slurry is dried using a drying apparatus known in the art, provided that heat above about 60° C. is not used. Several such apparatuses, such as spray dryers, freeze dryer, ring dryers, dispersion dryers, drum dryers and fluid bed dryers, are commercially available.

In some embodiments, the PPI produced by the above process has a protein content in the range of about 80 to about 90 wt % (Nx6.25) on a dry basis. In other embodiments, the albumin enriched PPI has protein content in the range of about 80% to about 95% on a dry basis. In yet other embodiments, the PPI has protein content in the range of about 80% to about 99% on a dry basis. The processes allow for the protein of the PPI to substantially maintain its native form. The resulting pea protein isolate may then be used as further described below.

### Pea Protein Products

In addition to the processes described above, the present disclosure provides pea protein products produced by such processes, in particular pea protein isolates having particular useful characteristics. The pea protein isolate is referred to herein as PPI. The PPI produced by the processes described above have the important feature of becoming certified organic by the USDA. Importantly, the processes described herein produce PPI in similar yields and similar purity (i.e., 80-95% protein) to conventional methods, and the PPI protein substantially maintains its native form.

In many respects, the PPI produced by the processes herein have the characteristics and functionality of PPI produced using non-organic standard processes. The PPI produced by the processes herein has identical protein composition to baseline PPI (precipitated using HCl), based on LabChip analysis.

In some embodiments, the pea protein isolate produced by the above processes is reduced sodium pea protein isolate. For the purposes of the present disclosure, percent sodium, percent potassium and percent magnesium content are measured as wt % on a dry basis. In Some embodiments, the PPI of the present invention has sodium content of 0.5% to 0.9%. In some embodiments, the PPI of the present invention has sodium content of <0.6%. The PPI of the present invention has sodium content of <0.55%, <0.56%, <0.57%, <0.58%, <0.59%, <0.60%, <0.61%, <0.62%, <0.63, <0.64%, <0.65%, <0.66%, <0.67%, <0, <0.68%, <0.69%, <0.70%, <0.71%, <0.72%, <0.73%, <0.74%, <0.75%, <0.76%, <0.77%, <0.78%, <0.79%, <0.80%, <0.81%, >0.82%, <0.83%, <0.84%, <0.85%, <0.86%, <0.87%, <0.88%, <0.89% or <0.90%.

In some embodiments, sodium content of the PPI of the invention is reduced by up to 45% over Conventional Sodium PPI. In certain embodiments, the PPI of the present invention has 44% less sodium, 43% less sodium, 42% less sodium, 41% less sodium, 40% less sodium, 39% less sodium, 38% less sodium, 37% less sodium, 36% less sodium, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, or 7% less sodium than Conventional Sodium PPI.

In some embodiments, the reduced sodium PPI produced by the above process has unique functionality as compared with Conventional Sodium PPI. Such functionality may be, but is not limited to, foaming ability, emulsify ability, gelling ability, and ability to stay soluble at acidic pHs.

In some embodiments, the PPI produced by the above process has unique functionality as compared with baseline PPI. While lactic acid PPI has similar oil holding capacity (OHC) and water holding capacity (WHC) as baseline PPI, lactic acid PPI generally showed higher solubility as compared with baseline PPI. Viscosity of lactic acid PPI is also higher than baseline PPI at 25° C. In some embodiments, the lactic acid PPI has Standard Solubility of at least (≥) 50%. In certain embodiments, the lactic acid PPI has protein Standard Solubility of at least (≥) 51%, 52%, 53%, 54%, 55%, 56%, 57%, 58%, 59%, 60%, 61% 62%, 63% 64% or 65%. In certain embodiments the lactic acid PPI has High Shear Solubility of at least (≥) 60%. In certain embodiments, the lactic acid PPI has protein Standard Solubility of at least (≥) 61% 62%, 63% 64%, 65%, 66%, 67%, 68%, 69%, 70%, 71%, 72%, 73%, 74% or 75%. In some embodiments the lactic acid PPI has High Temperature Solubility of at least (≥) 70%. In certain embodiments, the lactic acid PPI has High Temperature Solubility of at least (2) 71%, 72%, 73%, 74% or 75%. In some embodiments the lactic acid PPI has High Shear/High Temperature Solubility of at least (≥) 75%. In certain embodiments, the lactic acid PPI has High Temperature Solubility of at least (≥) 76%, 77%, 78%, 79% or 80%.

In some embodiments, the PPI produced by the above process has higher viscosity at 25° C. as compared with baseline PPI. In some embodiments the lactic acid PPI viscosity at 25° C. is at least 90 cP. In certain embodiments the lactic acid PPI has viscosity at 25° C. of at least (≥) 90.5 cP, 91.0 cP, 91.5 cP, 92.0 cP, 92.5 cP, 93.0 cP, 93.5 cP, 94.0 cP, 94.5 cP, 95.0 cP, 95.5 CP, 96.0 cP, 96.5 cP, 97.0 cP, 97.5 cP, 98.0 cP or 98.5 cP.

In some embodiments, the PPI produced by the above process has improved organoleptic properties as compared with baseline PPI. In certain embodiments, the lactic acid PPI has a less beany flavor as compared with baseline PPI. Similarly, malic acid PPI has a less beany flavor as compared with baseline PPI and a DOD of at least (≥) 2.0. In certain embodiments, the malic acid PPI has a DOD of at least (≥) 2.1, 2.2, 2.3, 2.4, 2.5, 2.6, 2.7, 2.8, 2.9, 3.0, 3.1, 3.2, 3.3, 3.5 or 3.5. In certain embodiments the malic acid PPI has a DOD of at least (≥) 0.40 greater than baseline PPI. In some embodiments the malic acid PPI has a DOD of at least (≥) 0.45, 0.50, 0.55, 0.60, 0.65, 0.70, 0.75, 0.80, 0.85, 0.90, 0.95, 1.00, 105, 1.10, 1.15, 1.20, 1.25, 1.30 or 1.35 greater than baseline PPI.

In some embodiments, the reduced sodium PPI contains, but is not limited to, globulin, legumin, vicilin, convicilin, albumin, PA-I albumin, PA-II albumin, lectins, prolamin, glutelin.

### Use of Lactic Acid PPI and Malic Acid PPI

In some aspects, the present disclosure further provides use of the lactic acid PPI or malic acid PPI of the present disclosure in the production of a foam.

In some aspects, the present disclosure further provides use of the lactic acid PPI or malic acid PPI of the present disclosure in the production of a gel.

In some aspects, the present disclosure further provides use of the lactic acid PPI or malic acid PPI of the present disclosure in the production of an emulsion. In some embodiments, the emulsion is made from a mixture of equal parts oil and water.

In some aspects, the present disclosure provides a foam comprising the lactic acid PPI or malic acid PPI of the present disclosure.

In some aspects, the present disclosure provides a gel comprising the lactic acid PPI or malic acid PPI of the present disclosure.

In some aspects, the present disclosure provides an emulsion comprising the lactic acid PPI or malic acid PPI of the present disclosure.

In some aspects, the present disclosure provides use of the lactic acid PPI or malic acid PPI of the present disclosure in a food or beverage application. In some embodiments, the food or beverage application is selected from milk shake, protein bars, meat analogues, confectionary, condiments, mayonnaise, salad dressing, nutritional supplements and diary alternatives. In certain embodiments, the dairy alternative is selected from creamers, ice cream, yogurt, buttermilk and cheese.

In yet other aspects, the present disclosure provides a food or beverage comprising the lactic acid PPI or malic acid PPI of the present disclosure.

### Exemplary Non Limiting Aspects of the Disclosure

Aspects, including embodiments, of the present subject matter described above may be beneficial alone or in combination, with one or more other aspects or embodiments. Without limiting the foregoing description, certain non-limiting aspects of the disclosure numbered 1-78 are provided below. As will be apparent to those of skill in the art upon reading this disclosure, each of the individually numbered aspects may be used or combined with any of the preceding or following individually numbered aspects. This is intended to provide support for all such combinations of aspects and is not limited to combinations of aspects explicitly provided below:
1. A process for producing a pea protein product comprising:
isoelectric precipitation of protein from a protein-rich solution derived from a pea source, wherein said precipitation is induced by adding lactic acid or I-Malic acid to said solution to lower the pH.
2. The process of aspect 1, wherein the isoelectric precipitation induction is exclusive of other acids.
3. The process of aspect 1, wherein the precipitation is induced by lactic acid.
4. The process of aspect 1, wherein the precipitation is induced by L-Malic acid.
5. A process for producing pea protein isolate comprising:
   a) providing a pea source,
   b) extracting protein from the pea source in a basic solution to produce a protein-rich solution,
   c) separating the pea source from the protein-rich solution, and
   d) precipitating protein from the protein-rich solution by reducing the pH of the solution by adding lactic acid or L-Malic acid to obtain a pea protein isolate.
6. The process of aspect 5, wherein said pea source is pea pulse.
7. The process of aspect 5, wherein said pea source is pea pulse flour.
8. The process of aspect 7, wherein said pea pulse flour is from a yellow pea.
9. The process of aspect 5, wherein the basic solution is an aqueous solution.
10. The process of aspect 5, wherein the extracting is performed at a pH of 7.0-10.5.
11. The process of aspect 10, wherein the extracting is performed at a pH of 7.5-9.5.
12. The process of aspect 5, wherein the extracting solution is made basic using NaOH.
13. The process of aspect 5, wherein the extracting solution is made basic using NaOH and Mg(OH)₂.
14. The process of aspect 5, wherein the extracting solution is made basic using NaOH and KOH.
15. The process of aspect 5, wherein separating the pea source is by centrifugation, filtration or decanting.
16. The process of aspect 5, wherein the precipitating is performed using lactic acid as the only acid source.
17. The process of aspect 5, wherein the precipitating is performed using L-Malic acid as the only acid source.
18. The process of aspect 5, wherein the lactic acid is food grade (FG) lactic acid.
19. The process of aspect 5, wherein the lactic acid is 88% FG lactic acid.
20. The process of aspect 5, wherein the L-Malic acid is 1M L-Malic acid.
21. The process of aspect 5, wherein in the precipitation step the pH is lowered to below 5.0.
22. The process of aspect 5, wherein in the precipitation step the pH is lowered to about 4.5.
23. The process of aspect 5, further comprising:
   e) isolating the pea protein isolate, comprising:
      i. removing the solution from the protein isolate,
      ii. optionally washing the protein with a solution at precipitate pH,
      iii. diluting the protein with water and adjusting the pH to about 7.0,
      iv. homogenizing the diluted protein,
      v. optionally sterilizing the protein, and
      vi. drying the protein.
24. The process of aspect 23, wherein the diluting is with water at about 2× volume of the pea protein isolate.
25. The process of aspect 23, wherein the homogenizing is performed with a high pressure homogenizer.
26. The process of aspect 23, wherein the sterilizing is performed by direct steam injection.
27. The process of aspect 23, wherein the drying is by spray drying or freeze/spray drying.
28. The process of aspect 5, further comprising:
   e) isolating the pea protein isolate from the solution,
   f) optionally washing the protein isolate with a solution at precipitate pH,
   g) diluting the protein isolate with water,
   h) neutralizing the protein isolate by increasing its pH to about 7.0,
   i) optionally homogenizing the protein isolate,
   j) optionally sterilizing the protein isolate, and
   k) optionally drying the protein.
29. The process of aspect 28, wherein said neutralizing is performed by adding NaOH and Mg(OH)₂.
30. The process of aspect 28, wherein said neutralizing is performed by adding NaOH and KOH.
31. The process of aspect 28, wherein said neutralizing is performed by adding NaOH to bring the protein isolate to a predetermined pH, then adding Mg(OH)₂ or KOH to bring the protein isolate to a pH of about 7.0.
32. The process of aspect 31, wherein said predetermined pH is in the range of pH 5 to pH 6.9.
33. The process of aspect 32, wherein said predetermined pH is selected from the group consisting of pH 5.0, pH 5.1, pH 5.2, pH 5.3, pH 5.4, pH 5.5, pH 5.6, pH 5.7, pH 5.8, pH 5.9, pH 6.0, pH 6.1, pH 6.2, pH 6.3, pH 6.4, pH 6.5, pH 6.6, pH 6.7, pH 6.8 and pH 6.9.
34. A pea protein product produced by the process of any one of aspects 1-33.
35. The pea protein product of aspect 34 that is ≥80% protein.
36. A pea protein isolate that is organic by USDA Organic certification standards.
37. The pea protein isolate of aspect 36 having reduced sodium as compared with a Conventional Sodium PPI.
38. A pea protein isolate comprising <0.2 ppm volatiles content.
39. A pea protein isolate comprising <1 mg/g saponin content.
40. The pea protein isolate of aspect 39 comprising <0.9 mg/g saponin content.
41. A pea protein isolate having a 8% protein solution viscosity of ≥90 cP at 25° C.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, temperature is in degrees Centigrade, and times are in minutes.

All publications and patent applications cited in this specification are herein incorporated by reference as if each individual publication or patent application were specifically and individually indicated to be incorporated by reference.

The present invention has been described in terms of particular embodiments found or proposed by the present inventor to comprise preferred modes for the practice of the invention. It will be appreciated by those of skill in the art that, in light of the present disclosure, numerous modifications and changes can be made in the particular embodiments exemplified without departing from the intended scope of the invention. All such modifications are intended to be included within the scope of the appended claims.

### Example 1—Production of PPI

1A. Table 1 shows the procedural steps used to produce the baseline PPI using 1N HCl in the protein precipitation step (step 3).

TABLE 1

| No. | Extraction | Process details |
|---|---|---|
| 1 | Aqueous | pH of extraction: 9.5 |
| | Extraction | Time of extraction: 30 min |
| | | Temperature of extraction: 55° C. |
| 2 | Centrifugation | 5000 g for 10 minutes at room temperature |
| | | 15000 g for 30 min at 4° C. |
| 3 | Precipitation | Heat the protein supernatant from step 2 for 30 |
| | of protein | min at a temperature of 60° C. |
| | | Add 1N HCl to lower pH to 4.5 |
| | | Precipitation of protein at pHs 4.5 for 30 min |
| | | Precipitation temperature: 55° C. |
| 4 | Washing of | Washing the protein with 2x water at precipitation |
| | protein isolate | pHs |
| | from step 3 | |
| 5 | Dilution and | Diluting the protein slurry with water 2x volume |
| | Neutralization | of slurry and adjust its pH to pH 7 using 1N |
| | | NaOH |
| 6 | Homogeniza- | Homogenizing the protein slurry using a high- |
| | tion and | pressure homogenizer |
| | Sterilization | Sterilizing the protein slurry in a direct steam |
| | | injection [DSI (120and 140° C. for 6 seconds and |
| | | 30 seconds)] |
| 7 | Drying | Drying the protein slurry by a freeze/spray drier |

1B. Table 2 shows the procedural steps used to produce the lactic acid PPI using 88% FG lactic acid in the protein precipitation step (step 3).

TABLE 2

| No. | Extraction | Process details |
|---|---|---|
| 1 | Aqueous | pH of extraction: 9.5 |
| | Extraction | Time of extraction: 30 min |
| | | Temperature of extraction: 55° C. |
| 2 | Centrifugation | 5000 g for 10 minutes at room temperature |
| | | 15000 g for 30 min at 4° C. |
| 3 | Precipitation | Heat the protein supernatant from step 2 for 30 |
| | of protein | min at a temperature of 60° C. |
| | | Add 88% FG lactic acid to lower pH to 4.5 |
| | | Precipitation of protein at pHs 4.5 for 30 min |
| | | Precipitation temperature: 55° C. |
| 4 | Washing of | Wash the protein with 2x water at precipitation |
| | protein isolate | pHs |
| | from step 3 | |
| 5 | Dilution and | Diluting the protein slurry with water 2x volume |
| | Neutralization | of slurry and adjust its pH to pH 7 using 1N |
| | | NaOH |
| 6 | Homogeniza- | Homogenizing the protein slurry using a high- |
| | tion and | pressure homogenizer |
| | Sterilization | Sterilizing the protein slurry in a direct steam |
| | | injection [DSI (120and 140° C. for 6 seconds and |
| | | 30 seconds)] |
| 7 | Drying | Drying the protein slurry by a freeze/spray drier |

1C. Table 3 shows the procedural steps used to produce the low sodium lactic acid PPI using 88% FG lactic acid in the protein precipitation step (step 3) and 1M Mg(OH)₂ in the neutralization step (step 5).

TABLE 3

| No. | Extraction | Process details |
|---|---|---|
| 1 | Aqueous | pH of extraction: 9.5 |
| | Extraction | Time of extraction: 30 min |
| | | Temperature of extraction: 55° C. |
| 2 | Centrifugation | 5000 g for 10 minutes at room temperature |
| | | 15000 g for 30 min at 4° C. |
| 3 | Precipitation | Heat the protein supernatant from step 2 for 30 |
| | of protein | min at a temperature of 60° C. |
| | | Add 88% FG lactic acid to lower pH to 4.5 |
| | | Precipitation of protein at pHs 4.5 for 30 min |
| | | Precipitation temperature: 55° C. |
| 4 | Washing of | Wash the protein with 2x water at precipitation |
| | protein isolate | pHs |
| | from step 3 | |
| 5 | Dilution and | Diluting the protein slurry with water 2x volume |
| | Neutralization | of slurry and adjust its pH to pH 7 using 1N |
| | | NaOH and 1M Mg(OH)₂ |
| 6 | Homogeniza- | Homogenizing the protein slurry using a high- |
| | tion and | pressure homogenizer |
| | Sterilization | Sterilizing the protein slurry in a direct steam |
| | | injection [DSI (120and 140° C. for 6 seconds and |
| | | 30 seconds)] |
| 7 | Drying | Drying the protein slurry by a freeze/spray drier |

1D. Table 4 shows the procedural steps used to produce the malic acid PPI using 1M L-Malic acid in the protein precipitation step (step 3).

TABLE 4

| No. | Extraction | Process details |
|---|---|---|
| 1 | Aqueous | pH of extraction: 9.5 |
| | Extraction | Time of extraction: 30 min |
| | | Temperature of extraction: 55° C. |
| 2 | Centrifugation | 5000 g for 10 minutes at room temperature |
| | | 15000 g for 30 min at 4° C. |
| 3 | Precipitation | Heat the protein supernatant from step 2 for 30 |
| | of protein | min at a temperature of 60° C. |
| | | Add 1M L-Malic acid to lower pH to 4.5 |
| | | Precipitation of protein at pH 4.5 for 30 min |
| | | Precipitation temperature: 55° C. |
| 4 | Washing of | Wash the protein with 2x water at precipitation |
| | protein isolate | pHs |
| | from step 3 | |
| 5 | Dilution and | Dilute the protein slurry with water 2x volume |
| | Neutralization | of slurry and adjust its pH to pH 7 using 1N |
| | | NaOH |
| 6 | Homogeniza- | Homogenizing the protein slurry using a high- |
| | tion and | pressure homogenizer |
| | Sterilization | Sterilizing the protein slurry in a direct steam |
| | | injection [DSI (120and 140° C. for 6 seconds and |
| | | 30 seconds)] |
| 7 | Drying | Drying the protein slurry by a freeze/spray drier |

1E. Table 5 shows the procedural steps used to produce the low sodium malic acid PPI using 1M L-Malic acid in the protein precipitation step (step 3) and 1M Mg(OH)₂ in the neutralization step (step 5).

TABLE 5

| No. | Extraction | Process details |
|---|---|---|
| 1 | Aqueous | pH of extraction: 9.5 |
| | Extraction | Time of extraction: 30 min |
| | | Temperature of extraction: 55° C. |
| 2 | Centrifugation | 5000 g for 10 minutes at room temperature |
| | | 15000 g for 30 min at 4° C. |
| 3 | Precipitation of | Heat the protein supernatant from step 2 for 30 min |
| | protein | at a temperature of 60° C. |
| | | Add 1M L-Malic acid to lower pH to 4.5 |
| | | Precipitation of protein at pH 4.5 for 30 min |
| | | Precipitation temperature: 55° C. |
| 4 | Washing of protein | Wash the protein with 2x water at precipitation pHs |
| | isolate from step 3 | |
| 5 | Dilution and | Dilute the protein slurry with water 2x volume of |
| | Neutralization | slurry and adjust its pH to pH 7 using 1N NaOH and |
| | | 1M Mg(OH)₂ |
| 6 | Homogenization | Homogenizing the protein slurry using a high-pres- |
| | and Sterilization | sure homogenizer |
| | | Sterilizing the protein slurry in a direct steam injec- |
| | | tion [DSI (120and 140° C. for 6 seconds and 30 sec- |
| | | onds)] |
| 7 | Drying | Drying the protein slurry by a freeze/spray drier |

### Example 2—Mass Balance Analysis of PPI

2A. Mass Balance of one batch of lactic acid PPI (see Table 2) is shown in Table 6. Protein content was calculated using the Kjedahl method (NX6.25).

TABLE 6

| Step | Weight (g) | Protein (g) | Protein (%) |
|---|---|---|---|
| Starting Material | 100 | 29.8 | 29.8 |
| Post-Extraction (step | 316.39 | 18.92 | 5.98 |
| 1) | | | |
| Post-Acid Precipitation | 222.45 | 3.87 | 1.74 |
| (step 3) | | | |
| Post-Wash (step 4) | 149.25 | 0.69 | 0.46 |
| Neutralized Slurry | 189.14 | 16.27 | 8.60 |
| (step 5) | | | |
| Final Dried Material | 14.88 | 13.01 | 87.4 |
| (step 7) | | | |

Moisture content of final lactic acid PPI was 6.01 wt %. Protein content (db) was 12.082 g (92.9 wt %). Protein yield was 58.91% of starting protein. The final protein content and protein yield were similar to baseline PPI production (Table 1). LabChip® analysis of the lactic acid PPI showed an identical pattern of bands to that of the baseline PPI, indicating the composition of proteins in the lactic acid PPI and baseline PPI are the same.
2B. Mass Balance of one batch of low sodium lactic acid PPI (see Table 3) is shown in Table 7. Protein content was calculated using the Kjedahl method (NX6.25).

TABLE 7

| Step | Weight (g) | Protein (g) | Protein (%) |
|---|---|---|---|
| Starting Material | 100 | 29.8 | 29.8 |
| Post-Extraction | 325.78 | 19.31 | 5.93 |
| Acid Pellet | 75.64 | 15.96 | 21.1 |
| Final Dried Material | 15.01 | 13.20 | 88 |

Moisture content of final low sodium lactic acid PPI was 3.11 wt %. Protein content (db) was 11.99 g (90.8 wt %). Protein yield was 53.56% of starting protein. The final protein content and protein yield were similar to baseline PPI production (Table 1). LabChip® analysis of the low sodium lactic acid PPI showed an identical pattern of bands to that of the baseline PPI, indicating the composition of proteins in the low sodium lactic acid PPI and baseline PPI are the same.
2C. Mass Balance of one batch of malic acid PPI (see Table 4) is shown in Table 8. Protein content was calculated using the Kjedahl method (NX6.25).

TABLE 8

| Step | Weight (g) | Protein (g) | Protein (%) |
|---|---|---|---|
| Starting Material | 100 | 29.8 | 29.8 |
| Post-Extraction | 322.9 | 19.66 | 6.09 |
| Neutralized Slurry | 179.12 | 15.32 | 7.67 |
| Final Dried Material | 15.17 | 13.30 | 89.2 |

Moisture content of final malic acid PPI was 1.84 wt %. Protein content (db) was 12.08 g (90.8 wt %). Protein yield was 53.7% of starting protein. The final protein content and protein yield were similar to baseline PPI production (Table 1). LabChip® analysis of the malic acid PPI showed an identical pattern of bands to that of the baseline PPI, indicating the composition of proteins in the malic acid PPI and baseline PPI are the same.
2D. Mass Balance of one batch of low sodium malic acid PPI (see Table 5) is shown in Table 9. Protein content was calculated using the Kjedahl method (NX6.25).

TABLE 9

| Step | Weight (g) | Protein (g) | Protein (%) |
|---|---|---|---|
| Starting Material | 100 | 29.8 | 29.8 |
| Post-Extraction | 319.455 | 18.94 | 5.93 |
| Acid Pellet | 78.11 | 16.48 | 21.1 |
| Final Dried Material | 17.50 | 14.64 | 83.7 |

Moisture content of final low sodium malic acid PPI was 7.12 wt %. Protein content (db) was 13.21 g (90.2 wt %). Protein yield was 55.3% of starting protein. The final protein content and protein yield were similar to baseline PPI production (Table 1). LabChip® analysis of the low sodium malic acid PPI showed an identical pattern of bands to that of the baseline PPI, indicating the composition of proteins in the low sodium malic acid PPI and baseline PPI are the same.

### Example 3—Analysis of PPI

3A. Solubility of lactic acid PPI versus baseline PPI is shown in Table 10.

TABLE 10

| | | | | High |
|---|---|---|---|---|
| | | | | Shear/High |
| | Standard | High Shear | High Temp | Temp |
| | Solubility % | Solubility % | Solubility % | Solubility % |
| Lactic Acid PPI | 57% | 72% | 74% | 79% |
| Batch 1 | | | | |
| Lactic Acid PPI | 53% | 60% | 68% | 75% |
| Batch 2 | | | | |
| Lactic Acid PPI | 60% | 68% | 74% | 78% |
| Batch 3 | | | | |
| Baseline PPI | 47% | 57% | 69% | 74% |
| Batch 1 | | | | |

Standard Solubility of the lactic acid PPI was slightly higher than the baseline PPI, but in all other conditions (High Shear, High Temperature and High Shear/High Temperature) the solubility of lactic acid PPI was comparable to the baseline PPI.
3B. Solubility of low sodium lactic acid PPI versus baseline PPI is shown in Table 11.

TABLE 11

| | Standard | High Shear | High Temp |
|---|---|---|---|
| | Solubility % | Solubility % | Solubility % |
| Low Sodium Lactic | 27% | 30% | 24% |
| Acid PPI Batch 1 | | | |
| Low Sodium Lactic | 23% | 25% | 18% |
| Acid PPI Batch 2 | | | |
| Baseline PPI | 47% | 57% | 69% |
| Batch 1 | | | |

Solubility of low sodium lactic acid PPI in all conditions was lower than the baseline PPI.
3C. Solubility of malic acid PPI versus baseline PPI is shown in Table 12.

TABLE 12

| | Standard | High Shear | High Temp |
|---|---|---|---|
| | Solubility | Solubility | Solubility |
| Malic Acid PPI | 40% | 45% | 61% |
| Batch 1 | | | |
| Malic Acid PPI | 41% | 50% | 68% |
| Batch 2 | | | |
| Baseline PPI | 38% | 45% | 60% |
| Batch 2 | | | |

High Temperature Solubility of the malic acid PPI was slightly higher than the baseline PPI, but in all other conditions (Standard, High Shear) the solubility of malic acid PPI was comparable to the baseline PPI.
3D. Solubility of low sodium malic acid PPI versus baseline PPI is shown in Table 13.

TABLE 13

| | Standard | High Shear | High Temp |
|---|---|---|---|
| | Solubility | Solubility | Solubility |
| Low Sodium Malic | 27% | 29% | 22% |
| Acid PPI Batch 1 | | | |
| Low Sodium Malic | 26% | 27% | 21% |
| Acid PPI Batch 2 | | | |
| Baseline PPI | 38% | 45% | 60% |
| Batch 2 | | | |

Solubility of low sodium malic acid PPI in all conditions was lower than the baseline PPI.
3E. Viscosity at 25° C., Oil Holding Capacity, and Water Holding Capacity for lactic acid PPI are shown in Table 14. Viscosity of an 8% protein solution stirred for 15 minutes at 800 rpm, then adjusted to pH 7 and measure in a rheometer.

TABLE 14

| | Viscosity at 25° C. | OHC (g/g) | WHC (g/g) |
|---|---|---|---|
| Lactic Acid PPI | 90.29 | 7.42 | 4.68 |
| Batch 1 | | | |
| Lactic Acid PPI | 97.46 | 6.56 | 4.52 |
| Batch 2 | | | |
| Lactic Acid PPI | 90.29 | 7.62 | 3.18 |
| Batch 3 | | | |
| Baseline PPI | 54.50 | 7.22 | 4.80 |
| Batch 1 | | | |

Viscosity of the lactic acid PPI was noticeably higher than viscosity of the baseline PPI. Oil Holding Capacity and Water Holding Capacity were also very similar between both types of PPI.
3F. Viscosity at 25° C., Oil Holding Capacity, and Water Holding Capacity for malic acid PPI are shown in Table 15.

TABLE 15

| | Viscosity at 25° C. | OHC (g/g) | WHC (g/g) |
|---|---|---|---|
| Malic Acid PPI | 35.94 | 5.86 | 4.24 |
| Batch 1 | | | |
| Malic Acid PPI | 34.50 | 5.36 | 4.24 |
| Batch 2 | | | |
| Baseline PPI | 54.50 | 7.22 | 4.80 |
| Batch 1 | | | |

Viscosity of the malic acid PPI was slightly lower than viscosity of the baseline PPI. Oil Holding Capacity and Water Holding Capacity were also very similar between both types of PPI.
3G. Sodium content and magnesium content for low sodium lactic acid PPI are shown in Table 16.

TABLE 16

| | Na (ppm) | Mg (ppm) |
|---|---|---|
| Low Sodium Lactic | 9383.0 | 1541.4 |
| Acid PPI Batch 1 | | |
| Low Sodium Lactic | 8275.4 | 1999.8 |
| Acid PPI Batch 2 | | |
| Baseline PPI Batch 1 | 12625.0 | 488.7 |

Sodium content of low sodium lactic acid PPI is lower than sodium content of the baseline PPI, while magnesium content of low sodium lactic acid PPI is higher than magnesium content of the baseline PPI.
3H. Sodium content and magnesium content for low sodium lactic acid PPI are shown in Table 17.

TABLE 17

| | Na (ppm) | Mg (ppm) |
|---|---|---|
| Low Sodium Malic | 9748.5 | 1402.8 |
| Acid PPI Batch 1 | | |
| Low Sodium Malic | 9794.8 | 1554.3 |
| Acid PPI Batch 2 | | |
| Baseline PPI Batch 1 | 12054.0 | 400.5 |

Sodium content of low sodium malic acid PPI is lower than sodium content of the baseline PPI, while magnesium content of low sodium malic acid PPI is higher than magnesium content of the baseline PPI.
3I. Volatile content and saponin content for organic PPI are shown in Table 18.

TABLE 18

| | Volatiles (ppm) | Saponin (mg/g) |
|---|---|---|
| Lactic Acid PPI | 0.1 | 0.90 |
| Low Sodium Lactic | 0.2 | 0.87 |
| Acid PPI | | |
| Malic Acid PPI | 0.1 | 0.82 |
| Low Sodium Malic | 0.1 | 0.82 |
| Acid PPI | | |
| Baseline PPI Batch 1 | 0.2 | 1.20 |

3J. sensory analysis was performed on 4% (wt/vol) solutions of two batches of dried malic acid PPI in purified water and two batches of 4% dried baseline PPI (used as control samples), following the Degree of Difference (DOD) methodology of Aust et al., J. Food Science 50(5): 511-513 (1985). Briefly, panelists scaled overall difference for three pairs of samples-baseline PPI Batch 1 (C1) vs. C1, C1 vs. baseline PPI Batch 2 (C2), and C1 vs. each batch of malic acid PPI. The difference between the control and test was then compared to within-lot and between-lot variability of the control to establish if the control-test difference was significant. Results are shown in Table 19.

TABLE 19

| | Average DOD |
|---|---|
| | (sensory) |
| Malic Acid PPI | 2.33 |
| Batch 1 | |
| Malic Acid PPI | 3.14 |
| Batch 2 | |
| Baseline PPI Batch 2 | 1.86 |

DOD results indicate malic acid PPI has a very slight difference in flavor to baseline PPI. Despite this, hedonic sensory testing suggested that malic acid PPI tastes less beany than the baseline PPI.
3K. Informal sensory analysis was performed on 5% (wt/vol) solutions of three batches of dried lactic acid PPI in purified water and 5% baseline PPI. This informal sensory analysis determined that the lactic acid PPI tasted less beany than the baseline PPI.

While the present disclosure has been described with reference to the specific embodiments thereof, it should be understood by those skilled in the art that various changes may be made and equivalents may be substituted without departing from the true spirit and scope of the disclosure. In addition, many modifications may be made to adapt a particular situ-ation, material, composition of matter, process, process step or steps, to the objective, spirit and scope of the present disclosure. All such modifications are intended to be within the scope of the claims appended hereto.

1-4. (canceled)

5. A process for producing pea protein isolate comprising:
a) providing a pea source,
b) extracting protein from the pea source in a basic solution at pH 7.0-10.5 to produce a protein-rich solution,
c) separating the pea source from the protein-rich solution,
d) precipitating protein from the protein-rich solution by reducing the pH of the solution to below pH 5 by adding lactic acid or L-Malic acid to obtain a pea protein isolate,
wherein the pea protein isolate has increased solubility and increased viscosity relative to a pea protein isolate produced by precipitating protein from a protein-rich solution by reducing the pH of the solution using hydrochloric acid.

6. (canceled)

7. The process of claim 5, wherein said pea source is pea flour.

8-11. (canceled)

12. The process of claim 5, wherein the extracting solution is made basic using NaOH.

13. The process of claim 5, wherein the extracting solution is made basic using NaOH and Mg(OH)₂.

14. The process of claim 5, wherein the extracting solution is made basic using NaOH and KOH.

15-17. (canceled)

18. The process of claim 5, wherein the lactic acid is food grade (FG) lactic acid.

19. The process of claim 5, wherein the lactic acid is 88% FG lactic acid.

20-22. (canceled)

23. The process of claim 5, further comprising:
e) isolating the pea protein isolate, comprising:
i) removing the solution from the protein isolate,
ii) optionally washing the protein with a solution at precipitate pH,
iii) diluting the protein with water and adjusting the pH to about 7.0,
iv) homogenizing the diluted protein,
v) optionally sterilizing the protein, and
vi) drying the protein.

24. The process of claim 23, wherein the diluting is with water at about 2× volume of the pea protein isolate.

25-27. (canceled)

28. The process of claim 5, further comprising:
e) isolating the pea protein isolate from the solution,
f) optionally washing the protein isolate with a solution at precipitate pH,
g) diluting the protein isolate with water,
h) neutralizing the protein isolate by increasing its pH to about 7.0,
i) optionally homogenizing the protein isolate,
j) optionally sterilizing the protein isolate, and
k) optionally drying the protein.

29. The process of claim 28, wherein said neutralizing is performed by adding NaOH and Mg(OH)₂.

30. The process of claim 28, wherein said neutralizing is performed by adding NaOH and KOH.

31. The process of claim 28, wherein said neutralizing is performed by adding NaOH to bring the protein isolate to a predetermined pH, then adding Mg(OH)₂ or KOH to bring the protein isolate to a pH of about 7.0.

32. The process of claim 31, wherein said predetermined pH is in the range of pH 5 to pH 6.9.

33. (canceled)

34. A pea protein product produced by the process of claim 1.

35-38. (canceled)

39. A pea protein isolate comprising <1 mg/g saponin content.

40. The pea protein isolate of claim 39 comprising <0.9 mg/g saponin content.

41. (canceled)

42. A pea protein isolate produced by the process of claim 5.

43. The pea protein isolate of claim 42 that is organic by USDA Organic certification standards.
